(19) United States
(12) Patent Application Publication
(10) Pub. No.: US 2016/0360561 A1
(43) Pub. Date: Dec. 8, 2016

(54) OPTICALLY RECOGNIZED CODE FOR WIRELESS PAIRING

(71) Applicant: SEAGATE TECHNOLOGY LLC, Cupertino, CA (US)

(72) Inventors: Michael Lee, Palo Alto, CA (US); Ashutosh Razdan, San Jose, CA (US); Phillip Yin, Fremont, CA (US); Felix Markhovsky, Saratoga, CA (US)

(73) Assignee: SEAGATE TECHNOLOGY LLC, Cupertino, CA (US)

(21) Appl. No.: 14/732,432

(22) Filed: Jun. 5, 2015

(51) Int. Cl. H04W 76/02; H04N 5/232

(52) U.S. Cl. CPC H04W 76/021; H04N 5/23206; H04N 5/23293

(57) ABSTRACT

A method for establishing network connections is described. In one embodiment, the method includes receiving, via a processor of a first computing device, an input associated with enabling a second computing device to establish a connection with a network device, generating, via the processor, a customized encoded symbol based at least in part on the input, and providing, via the processor, the customized encoded symbol for use by the second computing device to establish the connection with the network device.

### SUMMARY

The disclosure herein includes methods and systems for establishing network connections. In some embodiments, the present systems and methods may include a first device being configured to enable a second device to establish a connection with a third device via the second device scanning an encoded symbol displayed on the first device.

A method for establishing network connections is described. In one embodiment, the method may include receiving, via a processor of a first computing device, an input associated with enabling a second computing device to establish a connection with a network device, generating, via the processor, a customized encoded symbol based at least in part on the input, and providing the customized encoded symbol for use by the second computing device to establish the connection with the network device.

In some embodiments, the method may include scanning, via a camera of the first computing device, a static encoded symbol attached to the network device. In some cases, the method may include decoding, via the processor, information from the scanned static encoded symbol and connecting, via the processor, the first computing device to the network device based on the decoded information. In one embodiment, the customized encoded symbol may be generated, via the processor, based at least in part on the decoded information.

In one embodiment, providing the customized encoded symbol may include displaying the customized encoded symbol on a display of the first computing device. In some cases, displaying the customized encoded symbol on the screen of the first computing device may enable the second computing device to establish the connection with the network device via the second computing device scanning the customized encoded symbol displayed on the first computing device. In some embodiments, the static encoded symbol and the customized encoded symbol include at least one of a linear barcode and a matrix barcode.

In some embodiments, the input may include at least one of a network device name, a password, a service set identifier (SSID), an internet protocol (IP) address, a wireless channel, a media access control (MAC) address, and an access policy. In some cases, access to at least a portion of a storage device of the network device may be limited based on the access policy encoded in the customized encoded symbol. In some embodiments, the access policy may include an expiration associated with the connection. For example, the expiration may specify when access to at least a portion the network device expires. In some cases, the customized encoded symbol may be generated via an application executing on the first computing device. The application may include one or more configuration settings for the network device and/or a user interface to the network device. In some embodiments, the network device may include one or more data storage devices.

A first apparatus for establishing network connections is also described. In one embodiment, the first apparatus may include a processor, memory in electronic communication with the processor, and instructions stored in the memory. The instructions may be executable by the processor to perform the steps of receiving an input associated with enabling a second apparatus to establish a connection with a network device, generating a customized encoded symbol based at least in part on the input, and providing the customized encoded symbol for use by the second apparatus to establish the connection with the network device.

A non-transitory computer-readable medium is also described. The non-transitory computer readable medium may store computer-executable code, wherein the code is executable by a processor of a first computing device to perform the steps of receiving an input associated with enabling a second computing device to establish a connection with a network device, generating a customized encoded symbol based at least in part on the input, and providing the customized encoded symbol for use by the second computing device to establish the connection with the network device.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein—including their organization and method of operation—together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components—including those having a dash and a second reference label—apply to other similar components. If only the first reference label is used in the specification, the description is applicable to any one of the similar components having the same first reference label irrespective of the second reference label.

FIG. 1 is a block diagram of an example of a system in accordance with various embodiments;

FIG. 2 shows a block diagram of a device in accordance with various aspects of this disclosure;

FIG. 3 shows a block diagram of a device in accordance with various aspects of this disclosure;

FIG. 4 shows a diagram of a system in accordance with various aspects of this disclosure;

FIG. 5 shows a diagram of a device in accordance with various aspects of this disclosure;

FIG. 6 shows a diagram of a system in accordance with various aspects of this disclosure;

FIG. 7 shows a block diagram of a system in accordance with various aspects of this disclosure;

FIG. 8 is a flow chart illustrating an example of a method in accordance with various aspects of this disclosure; and

FIG. 9 is a flow chart illustrating another example of a method in accordance with various aspects of this disclosure.

### DETAILED DESCRIPTION

The following relates generally to establishing network connections between two or more devices. In some embodiments, the present systems and methods may include a first device being configured to enable a second device to establish a connection with a third device via the second device scanning an encoded symbol displayed on the first device.

In some cases, the first device may acquire information regarding the third device via a scan of an encoded symbol on the third device. For example, a first device may scan a barcode such as a quick response (QR) code affixed to or carried by the third device. The scan may provide the first device with information such as a device name, a password, a service set identifier (SSID), a media access control (MAC) address, an internet protocol (IP) address, a wireless channel, and/or an access policy. The access policy may include a level of access, one or more permissions, a connection expiration, one or more allowed folders and/or one or more blocked folders.

Additionally, or alternatively, the first device may acquire information regarding the third device via input. For example, a device may be configured to enter information such as the device name, password, SSID, etc., via a user interface of an application installed on the first device. Additionally, or alternatively, a user may enter one or more inputs. With or without an established connection to the third device, the first device may use at least a portion of the information acquired by scanning the encoded symbol on the third device and/or the information acquired by user input to generate a customized encoded symbol.

The customized encoded symbol may include at least one of the device name, password, SSID, MAC address, IP address, wireless channel, and/or access policy with respect to the third device. The first device may display the customized encoded symbol on its screen. Accordingly, the second device may scan the customized encoded symbol displayed on the screen of the first device to acquire the information encoded in this customized encoded symbol.

Based on the information acquired, the second device may be enabled to establish a connection with the third device. In some cases, the connection between the second and third devices may be limited based on the information the second device acquired by scanning the customized encoded symbol. For example, the acquired information may include an expiration for the established connection, wherein once the expiration lapses the connection between the second and third devices is terminated. Additionally, or alternatively, the acquired information may specify that access to one or more areas of the third device is granted and/or specify that access to one or more areas of the third device is blocked. In some cases, the acquired information may specify the second device includes read-only access, write-only access, or read/write access. In some embodiments, the acquired information may specify the second device has administrator rights or general user rights in relation to the connection with the third device. Accordingly, the customized encoded symbol generated by the first device may enable the second device to establish a customized connection with the third device via scanning and decoding information from the customized encoded symbol displayed on the first device.

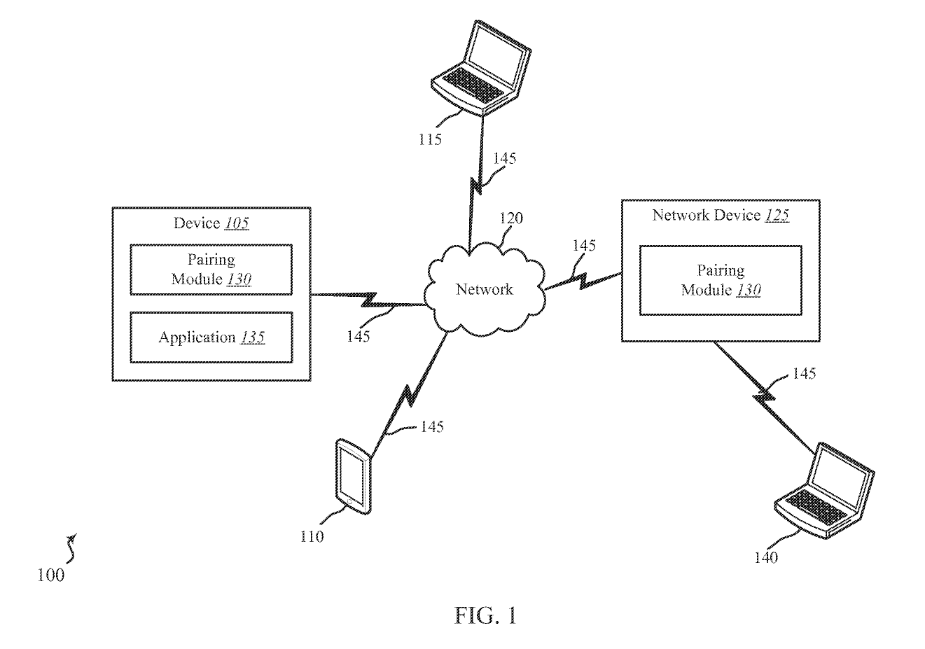

FIG. 1 is an example of a system 100 in accordance with various aspects of the disclosure. In some embodiments, the communications system 100 may include one or more computing devices 105, 110, 115, network 120, network device 125, and remote computing device 140. Device 105 may communicate via wired or wireless communication links 145 with one or more of the local computing device 110, 115, or network 120. The network 120 may enable devices 105, 110 and/or 115 to communicate via wired or wireless communication links 145 with the remote computing device 140 via network device 125. In alternate embodiments, the network 120 may be integrated with any one of the local computing devices 105, 110, 115, and/or remote computing device 140, such that each device may communicate with one of the other devices directly, such as device 105 communicating directly with device 110 using a wireless and/or wired connection.

Local computing devices 105, 110, 115 and remote computing device 140 may be custom computing entities configured to interact with network device 125 in conjunction with network 120. In other embodiments, local computing device 105, 110, 115 and remote computing device 140 may be general purpose computing entities such as a personal computing device, for example, a desktop computer, a laptop computer, a netbook, a tablet personal computer, a control panel, an indicator panel, an IPOD®, an IPAD®, an IPHONE®, a smart phone, a mobile phone, a personal digital assistant (PDA), and/or any other suitable device operable to send and receive signals, store and retrieve data, and/or execute modules.

In some embodiments, devices 105, 110, and/or 115 may be located remotely from network device 125. Additionally, remote computing device 140 may be located at the same premises as network device 125 or remotely from network device 125 at a different location from devices 105, 110, and/or 115. In some cases, device 105, 110, and/or 115 may be located at the same premises (e.g., same office, same home, etc.) as network device 125 and remote computing device 140 may be located at a different premises.

The local computing devices 105, 110, 115 may include memory, a processor, an output, a data input and a communication module. The processor may be a general purpose processor, a Field Programmable Gate Array (FPGA), an Application Specific Integrated Circuit (ASIC), a Digital Signal Processor (DSP), and/or the like. The processor may be configured to retrieve data from and/or write data to the memory. The memory may be, for example, a random access memory (RAM), a memory buffer, a hard drive, a database, an erasable programmable read only memory (EPROM), an electrically erasable programmable read only memory (EEPROM), a read only memory (ROM), a flash memory, a hard disk, a floppy disk, cloud storage, and/or so forth. In some embodiments, the local computing devices 105, 110, 115, remote computing device 140, and/or network device 125 may include one or more hardware-based modules (e.g., DSP, FPGA, ASIC) and/or software-based modules (e.g., a module of computer code stored at the memory and executed at the processor, a set of processor-readable instructions that may be stored at the memory and executed at the processor) associated with executing an application, such as, for example, pairing module 130. In some cases, pairing module 130 may be associated with executing an application such as application 135. Although application 135 is depicted as being on device 105, application 135 or a similar application may be on devices 110, 115, 125 and/or 140. Pairing module 130 and/or application 135 may allow device 105 to enable at least one of local computing device 110, 115 and/or remote computing device 140 to establish a connection with network device 125 via an encoded symbol generated by the first device. For example, device 105, in conjunction with pairing module 130 and/or application 135, may generate a customized encoded symbol, such as a QR code, by encoding information regarding establishing a connection with network device 125 into a customized encoded symbol and providing the customized encoded symbol to at least one of the devices 110, 115, 140. For example, device 105 may display the customized encoded symbol on its screen, enabling devices 110 and/or 115 to scan the symbol. In one embodiment, device 105 may provide the customized encoded symbol via network 120.

The processor of local computing devices 105, 110, and/or 115 may be operable to control operation of the output of the local computing devices 105, 110, 115. The output may be a television, a liquid crystal display (LCD) monitor, a cathode ray tube (CRT) monitor, speaker, tactile output device, and/or the like. In some embodiments, the output may be an integral component of the local computing devices 105, 110, 115. Similarly stated, the output may be directly coupled to the processor. For example, the output may be the integral display of a tablet and/or smart phone. In some embodiments, an output module may include, for example, a High Definition Multimedia Interface™ (HDMI) connector, a Video Graphics Array (VGA) connector, a Universal Serial Bus™ (USB) connector, a tip, ring, sleeve (TRS) connector, and/or any other suitable connector operable to couple the local computing devices 105, 110, 115 to the output. The local computing devices 105, 110, and/or 115 may be enabled to monitor network device 125 and/or remote computing device 140. The local computing devices 105, 110, and/or 115 may be functionally and/or structurally similar to the remote computing device 140 and may be operable to receive data streams from and/or send signals to network device 125 and/or remote computing device 140 via the network 120.

The remote computing device 140 may be a computing entity operable to enable a remote user to monitor network device 125 and/or at least one of devices 105, 110, 115. The remote computing device 140 may be operable to receive data streams from and/or send signals to network device 125 and/or at least one of the local computing devices 105, 110, 115 via the network 120.

Examples of networks 120 include cloud networks, local area networks (LAN), wide area networks (WAN), virtual private networks (VPN), a personal area network, BLUETOOTH®, near-field communication (NFC), a telecommunications network, wireless networks (using 802.11, for example), and/or cellular networks (using 3G and/or LTE, for example), etc. In some configurations, the network 120 may include the Internet and/or an intranet. The devices 105, 110, 115 and/or 140 may receive and/or send signals over the network 120 via wireless communication links 145 and network device 125. In some embodiments, a user may access the functions of local computing device 105, 110, 115 and/or network device 125 from remote computing device 140. Additionally, or alternatively, a user may access functions of network device 125, remote computing device 140, and/or local computing devices 110, 115 from local computing device 105. For example, in some embodiments, local computing device 105 may include a mobile application (e.g., application 135) that interfaces with one or more functions of network device 125, remote computing device 140, and/or local computing devices 110 or 115.

The network device 125 may be configured to communicate with the local computing devices 105, 110, 115 and the remote computing device 140. The network device 125 may perform additional processing on signals received from the computing devices 105, 110, 115, or may simply forward the received information to the remote computing device 140.

In one embodiment, network device 125 may be a computing device with one or more processors, memory, and/or one or more storage devices. In some cases, network device 125 may include a storage device such as a wireless storage device. In some embodiments, network device may include a cloud drive for a home or office setting. In one embodiment, network device 125 may include a network device such as a switch, router, access point, etc. In one example, network device 125 may be operable to receive data streams, store and/or process data, and/or transmit data from, to, or in conjunction with local computing device 105, 110, 115, and/or remote computing device 140. For example, network device 125 may send and/or receive a stream of data (e.g., music, photo and/or video) from one or more of devices 105, 110, 115, and/or 140.

The network device 125 may include a database. In some cases, the database may be internal to network device 125. Additionally, or alternatively, the database may include a connection to a wired and/or a wireless database. Additionally, as described in further detail herein, software (e.g., stored in memory) may be executed on a processor of the network device 125. Such software executed on the processor may be operable to cause the network device 125 to monitor, process, summarize, present, and/or send a signal associated with the operations described herein.

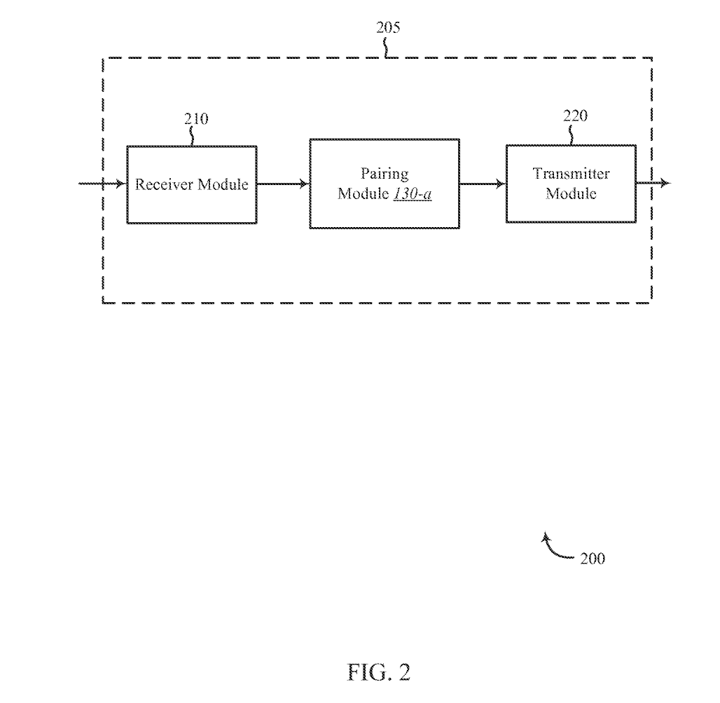

FIG. 2 shows a block diagram 200 of an apparatus 205 for use in electronic communication, in accordance with various aspects of this disclosure. The apparatus 205 may be an example of one or more aspects of a device 105, 110, 115, 125, and/or 140 described with reference to FIG. 1. The apparatus 205 may include a receiver module 210, a pairing module 130-a, and/or a transmitter module 220. The apparatus 205 may also be or include a processor. Each of these modules may be in communication with each other and/or other modules—directly and/or indirectly.

The components of the apparatus 205 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

The receiver module 210 may receive information such as packets, user data, and/or control information associated with various information channels (e.g., control channels, data channels, etc.). The receiver module 210 may be configured to receive signals and/or data from computing devices 105, 110, 115, and/or 140. Information may be passed on to the pairing module 130-a, and to other components of the apparatus 205.

The pairing module 130-a may be configured to enable a second device to establish a connection with a third device. The pairing module 130-a may acquire information associated with establishing the connection with the third device. The pairing module 130-a may encode this information into a customized encoded symbol. In conjunction with the pairing module 130-a, the apparatus 205 may provide the customized encoded symbol to the second device. The second device may decode the customized encoded symbol to acquire the information to enable the second device to establish a connection with the third device.

The transmitter module 220 may transmit the one or more signals received from other components of the apparatus 205. The transmitter module 220 may transmit signals and/or data to computing devices 105, 110, 115, and/or 140. In some cases, transmitter module 220 may transmit results of data analysis on signals and/or data analyzed by pairing module 130-a. For example, transmitter module 220 may transmit a customized encoded symbol generated by pairing module 130-a. In some examples, the transmitter module 220 may be collocated with the receiver module 210 in a transceiver module. In other examples, these elements may not be collocated.

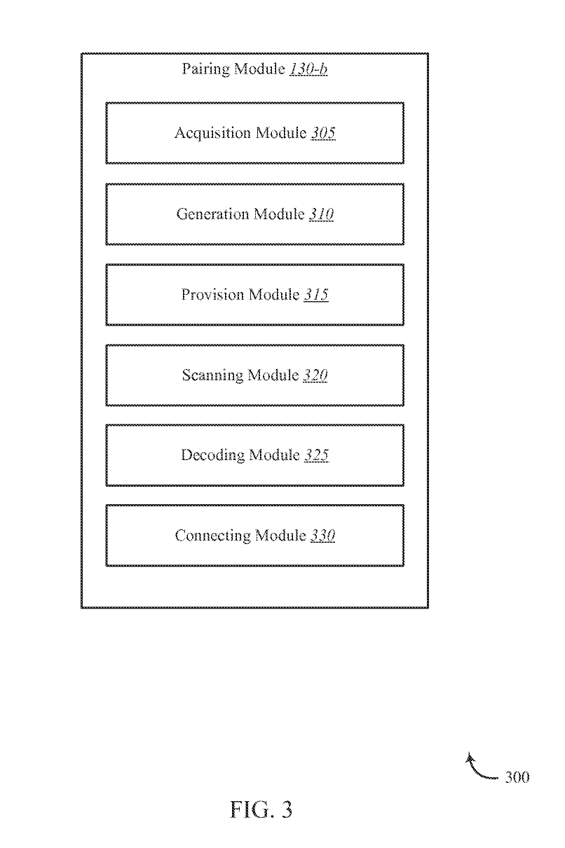

FIG. 3 shows a block diagram 300 of a pairing module 130-b. The pairing module 130-b may include and/or be operated using one or more processors, memory, and/or one or more storage devices. The pairing module 130-b may include acquisition module 305, generation module 310, provision module 315, scanning module 320, decoding module 325, and/or connecting module 330.

In one embodiment, acquisition module 305 may receive a user input associated with enabling a second computing device to establish a connection with a network device. In some cases, the network device may include one or more data storage devices. For example, the network device may include a wireless storage device. In one embodiment, the user input may be received in conjunction with a user entering data on a user interface associated with acquisition module 305. In some embodiments, generation module 310 may generate a customized encoded symbol based at least in part on the user input. In some cases, the customized encoded symbol may include at least one linear barcode. Examples of a linear barcode may include a Universal Product Code (UPC) barcode, a European Article Numbers (EAN) barcode, a telepen barcode, and the like. Additionally, or alternatively, the encoded symbol may include at least one matrix or two-dimensional barcode. Examples of a matrix or two-dimensional barcode may include a quick response (QR) code, Aztec code, MaxiCode, ShotCode, and the like. In some cases, the matrix barcode may include at least one color bar code such as a high capacity color barcode (HCCB) or MICROSOFT® tag.

In one embodiment, provision module 315 may provide the customized encoded symbol for use by the second computing device to establish the connection with the network device. As one example, the user input may include one or more of a network device name, a password, a service set identifier (SSID), an internet protocol (IP) address, a wireless channel, a media access control (MAC) address, and an access policy. In one embodiments, the user input may include simply an identifier of the network device such as a SSID and a password to connect with the network device. In some embodiments, the connection established via the second device may be limited in or more aspects. For example, the second device's access to at least a portion of the network device (e.g., at least a portion of a processor, memory, and/or storage device of the network device) may be limited based on the access policy encoded in the customized encoded symbol. Thus, the second device may acquire the customized encoded symbol (e.g., scanning an image of the symbol, receiving a file that includes the symbol, etc.), and decode the symbol to acquire information relating to how to connect the second device to the network device.

The acquired information may enable the second device to establish the connection with the network device while simultaneously providing and establishing the limitations associated with the established connection to the network device. For example, the access policy may include an expiration associated with the established connection, wherein the expiration specifies when access to at least a portion the network device expires. Thus, the acquired information may enable the second device to establish varied levels of access to the network device. For example, the acquired information may enable the second device to gain unlimited access to a first portion of the network device and limited access to a second portion.

As one example, the limited access may be limited to read-only access or write-only access wherein the unlimited access provides read/write access. Additionally, or alternatively, the limited access may be limited by expiration such as 7 days after establishing the connection, wherein the unlimited access may be granted without an expiration. In some embodiments, the limited access may provide general user access rights to at least a portion of the network device and administrator access rights to at least a portion of the network device. Accordingly, modules 305, 310, and/or 315 may enable a second device to gain customized access to a network device according to information encoded in a customized encoded symbol.

In one embodiment, scanning module 320 may scan a static encoded symbol attached to the network device. Decoding module 325 may decode information from the scanned static encoded symbol. The decoded information may include information associated with establishing a connection with the network device. In some embodiments, the static encoded symbol may include at least one of a linear barcode and a matrix barcode. In some cases, the customized encoded symbol may be generated by the generation module 310 based at least in part on the information decoded, by the decoding module 325, from the static encoded symbol. In some embodiments, connecting module 330 may connect the first computing device to the network device based on the information decoded from the static encoded symbol.

In one embodiment, the provision module 315 providing the customized encoded symbol may include displaying the customized encoded symbol on a display of the first computing device. In some cases, displaying the customized encoded symbol on the screen of the first computing device may enable a second computing device to establish the connection with the network device via the second computing device scanning the customized encoded symbol displayed on the first computing device.

In one embodiment, the customized encoded symbol may be generated via an application executing on the first computing device. In some cases, the application may include one or more configuration settings for the network device. Additionally, or alternatively, the application may include a user interface to the network device. In some embodiments, the user interface of the application may allow a user to input information used by the generation module 310 to generate the customized encoded symbol.

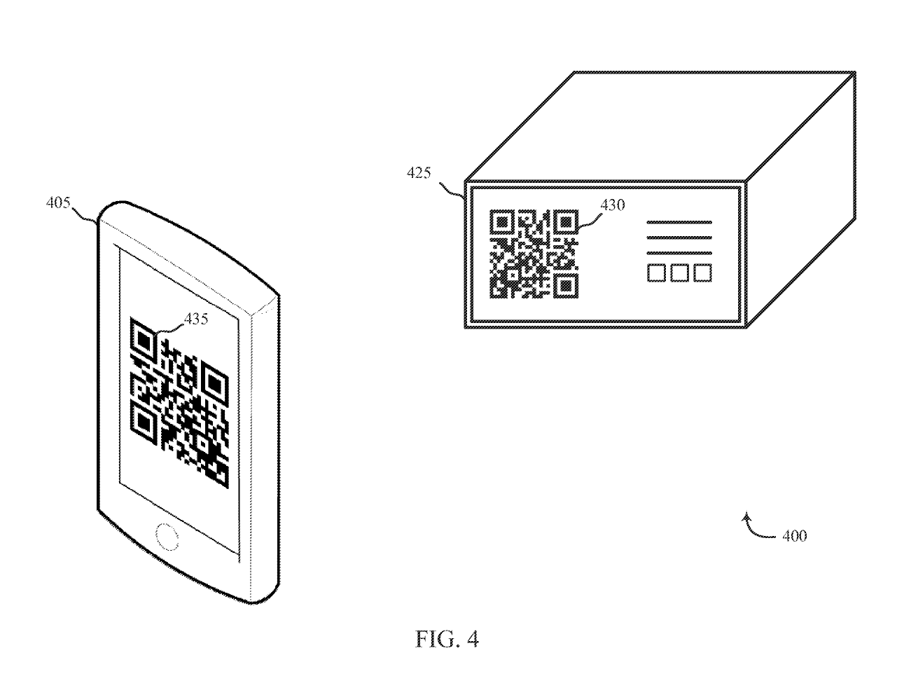

FIG. 4 shows a diagram of a system 400 in accordance with various aspects of this disclosure. The system 400 may include a device 405 and a network device 425. Device 405 may be one example of device 105, 110, 115, and/or 125 of FIG. 1. Network device 425 may be one example of network device 125 of FIG. 1.

As illustrated, network device 425 may include a static encoded symbol 430. As an example, the static encoded symbol 430 may include a QR code. Device 405 may include a camera. Using the camera, device 405 may capture an image 435 of the static encoded symbol 430 on network device 425. Device 405 may decode the image 435 to obtain information regarding establishing a connection with device 425. In some cases, device 405 may use the information obtained by decoding image 435 to generate a customized encoded symbol to enable a second device to connect to network device 425.

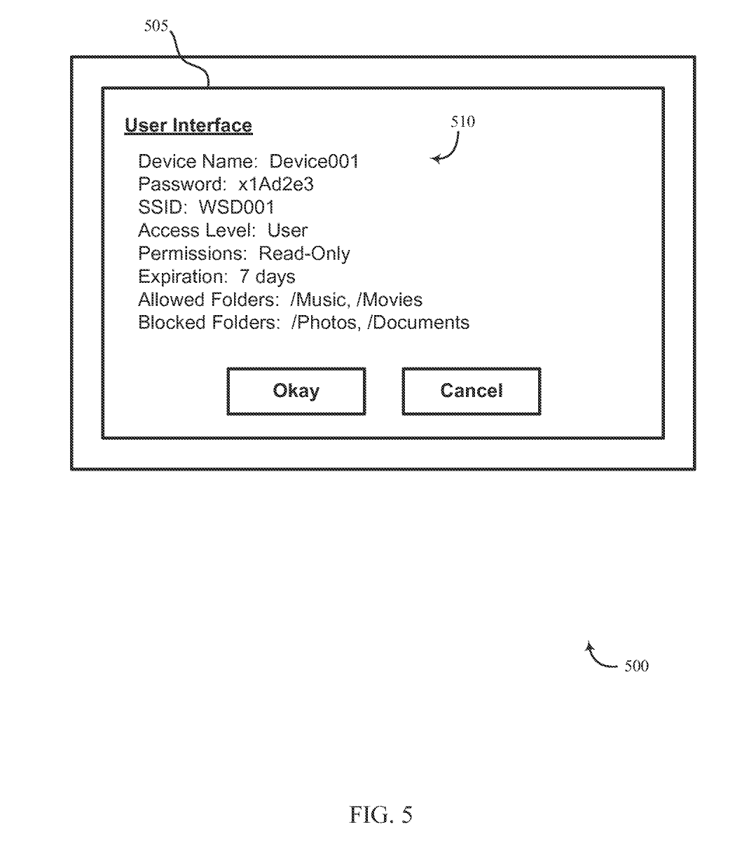

FIG. 5 shows a diagram of a device 500 in accordance with various aspects of this disclosure. Device 500 may be one example of device 105, 110, 115, 125, 140 of FIG. 1, apparatus 205 of FIG. 2, and/or device 405 of FIG. 4. In some cases, device 500 may be one example of network device 125 of FIG. 1 and/or network device 425 of FIG. 4. Device 500 may include a screen 505. On the screen 505, device 500 may display a user interface 510. In some embodiments, the user interface 510 may operate in conjunction with an application such as application 135 of FIG. 1. The user interface 510 may enable a user to provide one or more inputs to device 500. In one embodiment, device 500 may use at least a portion of the user inputs to generate a customized encoded symbol to enable a device to connect to another device. For example, the user input may enable device 500 to connect to a network device. Additionally, or alternatively, the user input may enable a separate device to connect to a network device.

As one example, the user input may include a device name and a password for authentication. The user input may also include an SSID. Once authenticated, a device may be allowed to establish a connection to the network device. The established connection, however, may be limited based on an access policy specified in the user input. As illustrated, the access policy specified in the user input may include an access level, permissions, an expiration, allowed folders, and/or blocked folders. For example, the access policy may include an access level. The access level may specify a level of access that a connected device is given in relation to an established connection with the network device. For example, a device may be given a “user” access level, wherein the device may perform general user actions on the network drive such as read a file or execute an application, but is blocked from changing systems settings and/or installing software, etc. Additionally, or alternatively, the access policy may include permissions such as read-only, write-only, or read/write permission. In one embodiment, the access policy may specify an expiration for any connection established via a customized encoded symbol generated according to the user input. Thus, when a second computing device establishes a connection via the customized encoded symbol, the established connection may end upon the expiration lapsing.

In some embodiments, the user input may specify a first access policy for a first portion of the network device and a second access policy for a second portion of the network device. For example, the first access policy may specify an expiration while the second access policy may specify a different expiration or specify no expiration. Accordingly, the second computing device may establish a connection that includes both first and second portions of the network device via the customized encoded symbol. Upon lapsing the expiration to the first portion, the second computing device may lose access to the first portion while remaining connected to the second portion of the network device. If the second portion does not include an expiration, the second computing device may continue to access the second portion. If the second portion does include a different expiration, the second computing device may continue to access the second portion until the second expiration lapses. In some cases, the access policy may specify which folders of a storage device on the network device the second computing device is allowed to access. Additionally, or alternatively, the access policy may specify which folders the second computing device are blocked from access. In some embodiments, the user input may specify that the network device use a separate dynamic IP address to connect with the second computing device. Thus, the first computing device may use a default IP address (e.g., static or dynamic IP address) and the second computing device may use a separate dynamic IP address to connect with the network device.

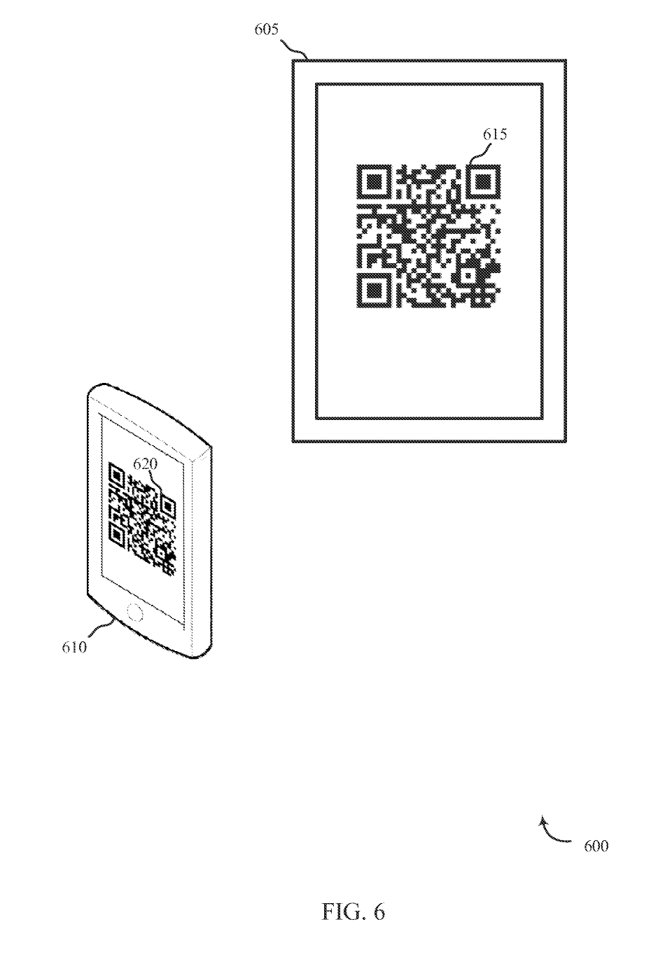

FIG. 6 shows a diagram of a system 600 in accordance with various aspects of this disclosure. The system may include a first device 605 and a second device 610. The first device 605 may be one example of device 105 of FIG. 1, apparatus 205 of FIG. 2, and/or device 405 of FIG. 4. The second device 610 may be one example of device 110, 115, and/or 125 of FIG. 1.

In one embodiment, first device 605 displays a customized encoded symbol 615 on its screen. The customized encoded symbol 615 may be generated and/or displayed in conjunction with an application such as application 135 of FIG. 1. The customized encoded symbol 615 may be generated based at least in part on user input and/or first device 605 scanning a static encoded symbol. The static encoded symbol may be affixed to, carried by, or otherwise available on the network device in some embodiments. Additionally, or alternatively, the static encoded symbol may be separate from the network device.

As illustrated, second device 610 may obtain, via a camera associated with second device 610 or an image 620 of the customized encoded symbol 615 displayed on first device 605. In some embodiments, second device 610 may obtain and/or decode the customized encoded symbol via an application such as application 135 of FIG. 1. Second device 610 may decode the customized encoded symbol to acquire information indicating how second device 610 may establish a connection with a network device. The decoded information may also include an access policy that may include any limitations associated with the connection established via the decoded information.

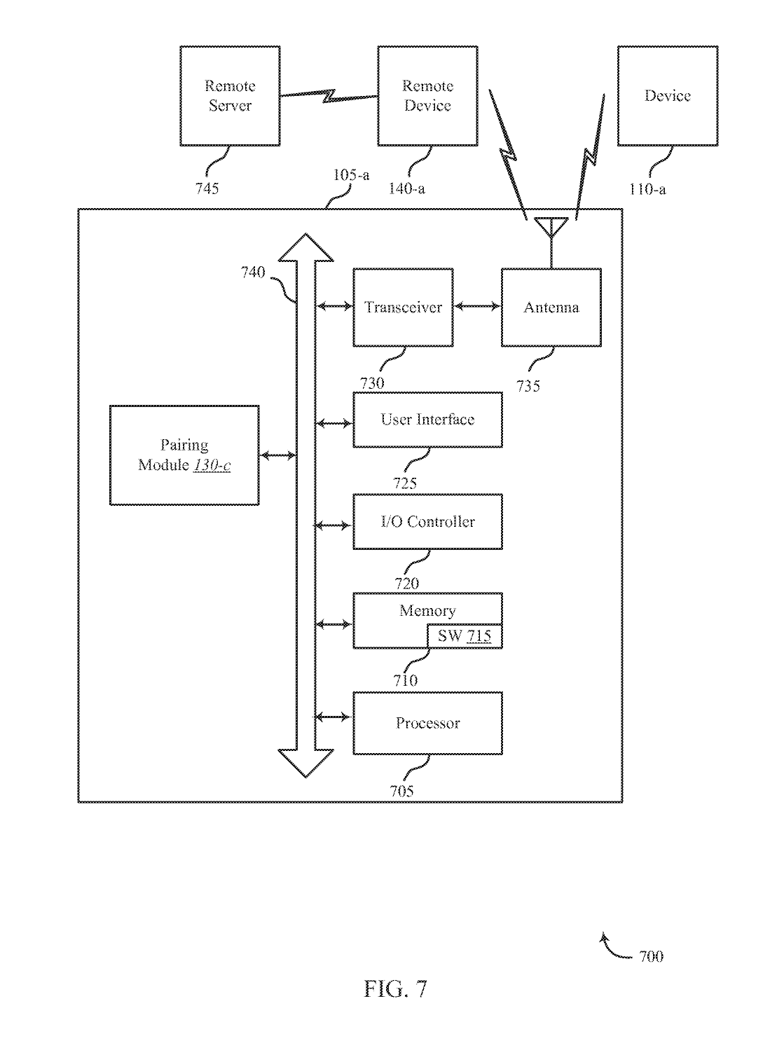

FIG. 7 shows a system 700 for use in automation systems, in accordance with various examples. System 700 may include an apparatus 105-a, which may be an example of device 105, 115, and/or 140 of FIG. 1. Apparatus 105-a may be an example of one or more aspects of apparatus 205, 405, 500, and/or 605 of FIGS. 2, 4, 5, and 6, respectively. Device 110-a may be one example of device 110 of FIG. 1.

Apparatus 105-a may include components for bi-directional voice and data communications including components for transmitting communications and components for receiving communications. For example, apparatus 105-a may communicate bi-directionally with one or more of device 110-a, remote device 140-a, and/or remote server 745, which may be an example of the remote server of FIG. 1. This bi-directional communication may be direct (e.g., apparatus 105-a communicating directly with remote device 140-a) and/or indirect (e.g., apparatus 105-a communicating indirectly with remote server 745 through remote device 140-a).

Apparatus 105-a may also include a processor module 705, a memory 710 (including software/firmware code (SW) 715), an input/output controller module 720, a user interface module 725, a transceiver module 730, and one or more antennas 735 each of which may communicate—directly or indirectly—with one another (e.g., via one or more buses 740). The software/firmware code 715 may be one example of application 135 of FIG. 1. The transceiver module 730 may communicate bi-directionally—via the one or more antennas 735, wired links, and/or wireless links—with one or more networks or remote devices as described above. For example, the transceiver module 730 may communicate bi-directionally with one or more of device 110-a, remote device 140-a, and/or remote server 745. The transceiver module 730 may include a modem to modulate the packets and provide the modulated packets to the one or more antennas 735 for transmission, and to demodulate packets received from the antenna 735. The apparatus 105-a may include multiple antennas 735 capable of concurrently transmitting or receiving multiple wired and/or wireless transmissions. In some embodiments, one element of apparatus 105-a (e.g., one or more antennas 735, transceiver module 730, etc.) may provide a direct connection to a remote server 745 via a direct network link to the Internet via a POP (point of presence). In some embodiments, one element of apparatus 105-a (e.g., one or more antennas 735, transceiver module 730, etc.) may provide a connection using wireless techniques, including digital cellular telephone connection, Cellular Digital Packet Data (CDPD) connection, digital satellite data connection, and/or another connection.

The signals associated with system 700 may include wireless communication signals such as radio frequency, electromagnetics, local area network (LAN), wide area network (WAN), virtual private network (VPN), wireless network (using 802.11, for example), 345 MHz, Z-WAVE®, cellular network (using 3G and/or LTE, for example), and/or other signals. The one or more antennas 735 and/or transceiver module 730 may include or be related to, but are not limited to, WWAN (GSM, CDMA, and WCDMA), WLAN (including BLUETOOTH® and Wi-Fi), WMAN (WiMAX), antennas for mobile communications, antennas for Wireless Personal Area Network (WPAN) applications (including RFID and UWB). In some embodiments, each antenna 735 may receive signals or information specific and/or exclusive to itself. In other embodiments, each antenna 735 may receive signals or information not specific or exclusive to itself.

In some embodiments, the user interface module 725 may include an audio device, such as an external speaker system, an external display device such as a display screen, a touch screen, and/or an input device (e.g., remote control device interfaced with the user interface module 725 directly and/or through I/O controller module 720).

One or more buses 740 may allow data communication between one or more elements of apparatus 105-a (e.g., processor module 705, memory 710, I/O controller module 720, user interface module 725, etc.).

The memory 710 may include random access memory (RAM), read only memory (ROM), flash RAM, and/or other types. The memory 710 may store computer-readable, computer-executable software/firmware code 715 including instructions that, when executed, cause the processor module 705 to perform various functions described in this disclosure (e.g., generate a customized encoded symbol to enable another device to establish a connection with a network device, etc.). Alternatively, the software/firmware code 715 may not be directly executable by the processor module 705 but may cause a computer (e.g., when compiled and executed) to perform functions described herein. Alternatively, the computer-readable, computer-executable software/firmware code 715 may not be directly executable by the processor module 705, but may be configured to cause a computer (e.g., when compiled and executed) to perform functions described herein. The processor module 705 may include an intelligent hardware device, e.g., a central processing unit (CPU), a microcontroller, an application-specific integrated circuit (ASIC), etc.

In some embodiments, the memory 710 can contain, among other things, the Basic Input-Output system (BIOS) which may control basic hardware and/or software operation such as the interaction with peripheral components or devices. For example, the pairing module 130-c to implement the present systems and methods may be stored within the system memory 710. Applications resident with system 700 are generally stored on and accessed via a non-transitory computer readable medium, such as a hard disk drive or other storage medium. Additionally, applications can be in the form of electronic signals modulated in accordance with the application and data communication technology when accessed via a network interface (e.g., transceiver module 730, one or more antennas 735, etc.).

Many other devices and/or subsystems may be connected to one or may be included as one or more elements of system 700 (e.g., entertainment system, personal computing device, mobile computing device, smart phone, server, internet-connected device, a vehicle computer system, wall mounted user interface device, cell radio module, home appliance monitor, utility equipment monitor, and so on). In some embodiments, all of the elements shown in FIG. 7 need not be present to practice the present systems and methods. The devices and subsystems can be interconnected in different ways from that shown in FIG. 7. In some embodiments, an aspect of some operation of a system, such as that shown in FIG. 7, may be readily known in the art and are not discussed in detail in this application. Code to implement the present disclosure can be stored in a non-transitory computer-readable medium such as one or more of system memory 710 or other memory. The operating system provided on I/O controller module 720 may be iOS®, ANDROID®, MS-DOS®, MS-WINDOWS®, OS/2®, UNIX®, LINUX®, or another known operating system.

The transceiver module 730 may include a modem configured to modulate the packets and provide the modulated packets to the antennas 735 for transmission and/or to demodulate packets received from the antennas 735. While the control panel or control device (e.g., 105-a) may include a single antenna 735, the control panel or control device (e.g., 105-a) may have multiple antennas 735 capable of concurrently transmitting and/or receiving multiple wireless transmissions. The apparatus 105-a may include a pairing module 130-c, which may perform the functions described above for the pairing modules 130 of FIGS. 1, 2, and/or 3.

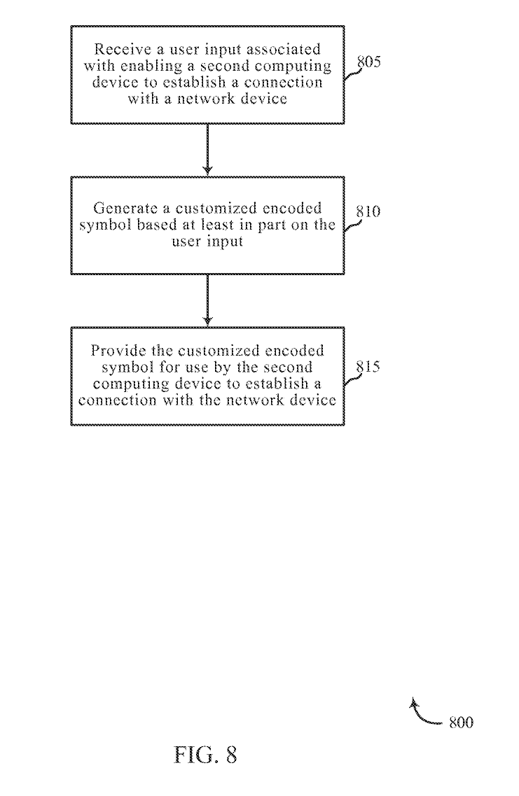

FIG. 8 is a flow chart illustrating an example of a method 800 for establishing a connection, in accordance with various aspects of the present disclosure. For clarity, the method 800 is described below with reference to aspects of one or more components of FIGS. 1-7. In some examples, a mobile computing device, a personal computer, and/or a server may execute one or more sets of codes to control the functional elements and/or perform one or more of the functions described below. Additionally or alternatively, mobile computing device, personal computer, and/or backend server may perform one or more of the functions described below using special-purpose hardware.

At block 805, the method may include a first computing device receiving a user input associated with enabling a second computing device to establish a connection with a network device. At block 810, the method may include generating a customized encoded symbol based at least in part on the user input. At block 815 the method may include providing the customized encoded symbol for use by the second computing device to establish the connection with the network device. The operations at blocks 805-815 may be performed using the pairing module 130 described with reference to FIGS. 1-3 and 7, and/or another module.

Thus, the method 800 may provide for establishing connections. It should be noted that the method 800 is just one implementation and that the operations of the method 800 may be rearranged, omitted, and/or otherwise modified such that other implementations are possible and contemplated.

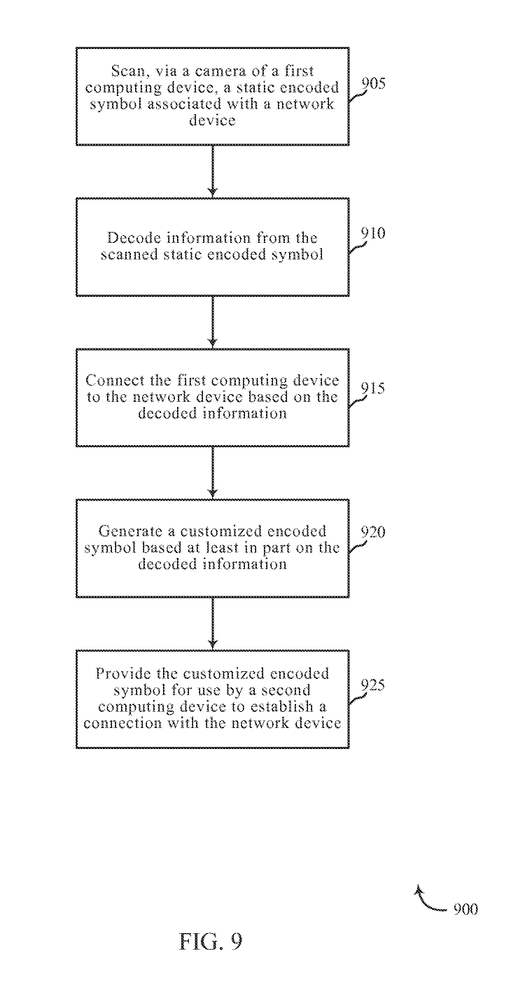

FIG. 9 is a flow chart illustrating an example of a method 900 for establishing a connection, in accordance with various aspects of the present disclosure. For clarity, the method 900 is described below with reference to aspects of one or more components of FIGS. 1-7. In some examples, a mobile computing device, a personal computer, and/or a server may execute one or more sets of codes to control the functional elements and/or perform one or more of the functions described below. Additionally or alternatively, mobile computing device, personal computer, and/or backend server may perform one or more of the functions described below using special-purpose hardware.

At block 905, the method may include scanning, via a camera of the first computing device, a static encoded symbol attached to a network device. At block 910, the method may include decoding information from the scanned static encoded symbol. At block 915, the method may include connecting the first computing device to the network device based on the decoded information. At block 920, the method may include generating a customized encoded symbol based at least in part on the decoded information. At block 925 the method may include providing the customized encoded symbol for use by the second computing device to establish the connection with the network device. The operations at blocks 905-925 may be performed using the pairing module 130 described with reference to FIGS. 1-3 and 7, and/or another module.

Thus, the method 900 may provide for establishing connections. It should be noted that the method 900 is just one implementation and that the operations of the method 900 may be rearranged, omitted, and/or otherwise modified such that other implementations are possible and contemplated.

In some examples, aspects from two or more of the methods 800 and 900 may be combined and/or separated. It should be noted that the methods 800 and 900 are just example implementations, and that the operations of the methods 800 and 900 may be rearranged or otherwise modified such that other implementations are possible.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, e.g., a combination of a DSP and a microprocessor, multiple microprocessors, one or more microprocessors in conjunction with a DSP core, and/or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc wherein disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

This disclosure may apply to security system applications. This disclosure may apply to automation system applications. In some embodiments, the concepts, the technical descriptions, the features, the methods, the ideas, and/or the descriptions may apply to security and/or automation system applications. Distinct advantages of such systems for these specific applications are apparent from this disclosure.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed:

1. A method for establishing network connections, comprising:
receiving, via a processor of a first computing device, an input associated with enabling a second computing device to establish a connection with a network device;
generating, via the processor of the first computing device, a customized encoded symbol based at least in part on the input; and
providing, via the processor, the customized encoded symbol for use by the second computing device to establish the connection with the network device.

2. The method of claim 1, comprising:
scanning, via a camera of the first computing device, a static encoded symbol attached to the network device.

3. The method of claim 2, comprising:
decoding, via the processor, information from the scanned static encoded symbol; and
connecting, via the processor, the first computing device to the network device based on the decoded information.

4. The method of claim 2, comprising:
decoding, via the processor, information from the scanned static encoded symbol;
wherein the customized encoded symbol is generated, via the processor, based at least in part on the decoded information.

5. The method of claim 1, wherein providing the customized encoded symbol includes displaying the customized encoded symbol on a display of the first computing device.

6. The method of claim 5, wherein displaying the customized encoded symbol on the display of the first computing device enables the second computing device to establish the connection with the network device via the second computing device scanning the customized encoded symbol displayed on the first computing device.

7. The method of claim 1, wherein the static encoded symbol and the customized encoded symbol include at least one of a linear barcode and a matrix barcode.

8. The method of claim 1, wherein the input comprises at least one of a network device name, a password, a service set identifier (SSID), an internet protocol (IP) address, a wireless channel, a media access control (MAC) address, and an access policy.

9. The method of claim 8, wherein access to at least a portion of the network device is limited based on the access policy encoded in the customized encoded symbol.

10. The method of claim 8, wherein the access policy includes an expiration associated with the connection, the expiration specifying when access to at least a portion the network device expires.

11. The method of claim 1, wherein the customized encoded symbol is generated via an application executing on the first computing device, the application comprising one or more configuration settings for the network device, and wherein the application includes a user interface to the network device.

12. The method of claim 1, wherein the network device comprises one or more data storage devices.

13. A first apparatus for establishing network connections, comprising:
a processor;
memory in electronic communication with the processor; and
instructions stored in the memory, the instructions being executable by the processor to perform the steps of:
receiving an input associated with enabling a second apparatus to establish a connection with a network device;
generating a customized encoded symbol based at least in part on the input; and
providing the customized encoded symbol for use by the second apparatus to establish the connection with the network device.

14. The apparatus of claim 13, the instructions being executable by the processor to perform the steps of:
scanning a static encoded symbol attached to the network device.

15. The apparatus of claim 14, the instructions being executable by the processor to perform the steps of:
decoding information from the scanned static encoded symbol; and
connecting the first computing device to the network device based on the decoded information.

16. The apparatus of claim 14, the instructions being executable by the processor to perform the steps of:
decoding information from the scanned static encoded symbol; and
the customized encoded symbol is generated based at least in part on the decoded information.

17. The apparatus of claim 13, wherein providing the customized encoded symbol includes displaying the customized encoded symbol on a display of the first computing device.

18. The apparatus of claim 17, wherein displaying the customized encoded symbol on the display of the first computing device enables the second apparatus to establish the connection with the network device via the second apparatus scanning the customized encoded symbol displayed on the first computing device.

19. The apparatus of claim 13, wherein the input comprises at least one of a network device name, a password, a service set identifier (SSID), an internet protocol (IP) address, a wireless channel, a media access control (MAC) address, and an access policy.

20. A non-transitory computer-readable medium storing computer-executable code for establishing network connections, the code being executable by a processor of a first computing device to perform the steps of:
receiving an input associated with enabling a second computing device to establish a connection with a network device;
generating a customized encoded symbol based at least in part on the input; and
providing the customized encoded symbol for use by the second computing device to establish the connection with the network device.
